(19) United States
(12) Patent Application Publication
(10) Pub. No.: US 2019/0026220 A1
(43) Pub. Date: Jan. 24, 2019

(54) STORAGE DEVICE THAT STORES LATENCY INFORMATION, PROCESSOR AND COMPUTING SYSTEM

(71) Applicant: SAMSUNG ELECTRONICS CO., LTD., Suwon-si (KR)

(72) Inventors: Sang-Geol LEE, Hanam-si (KR); Won-Ju LEE, Seongnam-si (KR); Eun-Woo JANG, Yongin-si (KR)

(21) Appl. No.: 15/861,326

(22) Filed: Jan. 3, 2018

(30) Foreign Application Priority Data
Jul. 21, 2017 (KR) 10-2017-0092989

(51) Int. Cl. G06F 12/02; G06F 13/24; G06F 13/22; G06F 13/16; G06F 3/06

(52) U.S. Cl. CPC G06F 12/0246; G06F 13/24; G06F 13/22; G06F 13/161; G06F 3/0649; G06F 2213/0028; G06F 3/0659; G06F 3/0679; G06F 3/0688; G06F 2213/0026; G06F 3/0611

(57) ABSTRACT

A computing system includes a storage device and a processor. The storage device includes a plurality of nonvolatile memory devices, and stores user data and latency information in the plurality of nonvolatile memory devices. The processor receives the latency information from the storage device, determines a polling delay time based on the latency information, transmits a storage device command to the storage device, and initiates polling that checks a state of the storage device, after expiration of the polling delay time, as determined from a time when the storage device command was transmitted.

### CROSS-REFERENCE TO RELATED APPLICATIONS

This U.S. non-provisional application claims priority under 35 U.S.C. § 119 from, and the benefit of, Korean Patent Application No. 10-2017-0092989, filed on Jul. 21, 2017 in the Korean Intellectual Property Office (KIPO), the contents of which are herein incorporated by reference in their entirety.

### BACKGROUND

### 1. Technical Field

Exemplary embodiments of the present inventive concept are directed to computing systems, and more particularly to storage devices that store latency information, processors that use the latency information stored in the storage devices, and computing systems that include the storage devices and the processors.

### 2. Discussion of the Related Art

When a processor performs an input/output operation for a storage device, the processor transmits a command, such as a write command or a read command, that corresponds to the input/output operation to the storage device, and performs a subsequent operation after checking that the storage device has completed the processing requested by the command. The processor may check the completion of the processing either by an interrupt request (IRQ) method or by polling. In an IRQ method, the processor checks the completion of the processing by receiving an interrupt from the storage device after the storage device has completed the processing requested by the command. In polling, to check completion of the processing, the processor periodically checks the state of the storage device after transmitting the command to the storage device. Polling can quickly execute an input/output operation by reducing or eliminating an interrupt transfer delay and can reduce or eliminate any context switching overhead associated with the interrupt. However, since the processor is periodically performing the polling operation, polling increases processor load or processor usage.

### SUMMARY

Some exemplary embodiments provide a computing system that can reduce processor usage caused by polling by using latency information stored in a storage device.

Some exemplary embodiments provide a processor that can reduce processor usage caused by polling by using latency information stored in a storage device.

Some exemplary embodiments provide a storage device that can store latency information used to reduce processor usage caused by polling.

According to exemplary embodiments, a computing system includes a storage device and a processor. The storage device includes a plurality of nonvolatile memory devices that store user data and latency information. The processor receives the latency information from the storage device, determines a polling delay time based on the latency information, transmits a storage device command to the storage device, and initiates a polling operation that checks a state of the storage device after expiration of the polling delay time, as determined from a time when the storage device command was transmitted.

According to exemplary embodiments, a processor executes instructions to perform method steps for operating a storage device. The method steps include receiving latency information from the storage device, determining a polling delay time based on the latency information, transmitting a storage device command to the storage device, and initiating a polling operation that checks a state of the storage device after expiration of the polling delay time, as determined from a time when the storage device command was transmitted. The processor is connected to the storage device.

According to exemplary embodiments, a storage device includes a plurality of nonvolatile memory devices. The storage device stores user data in the plurality of nonvolatile memory devices, and stores latency information used to determine a polling delay time of a storage device command.

As described above, in a storage device, processor and computing system according to exemplary embodiments, latency information is stored in a storage device, the polling delay time is determined based on the latency information stored in the storage device, and polling is initiated after the polling delay time from the time point of the transfer of the storage device command. Accordingly, a suitable polling delay time is determined for each storage device, and the processor usage caused by polling is reduced.

### BRIEF DESCRIPTION OF THE DRAWINGS

FIG. 1 is a block diagram that illustrates a computing system according to exemplary embodiments.

FIG. 2 is a block diagram of an example of a storage device according to exemplary embodiments.

FIG. 3 illustrates an example of a nonvolatile memory device included in a storage device of FIG. 2.

FIG. 4 is a circuit diagram of an example of a memory cell array included in a nonvolatile memory device of FIG. 3.

FIG. 5 illustrates an example of a virtual product data (VPD) page.

FIG. 6 is a timing diagram of an input/output operation in an interrupt request (IRQ) method, an input/output operation in a polling method, a first input/output operation in a processor- or user-based hybrid polling method, a second input/output operation in the processor- or user-based hybrid polling method, and an input/output operation in a device-based hybrid polling method according to exemplary embodiments.

FIG. 7 is a block diagram of a computing system according to exemplary embodiments.

### DETAILED DESCRIPTION OF THE EMBODIMENTS

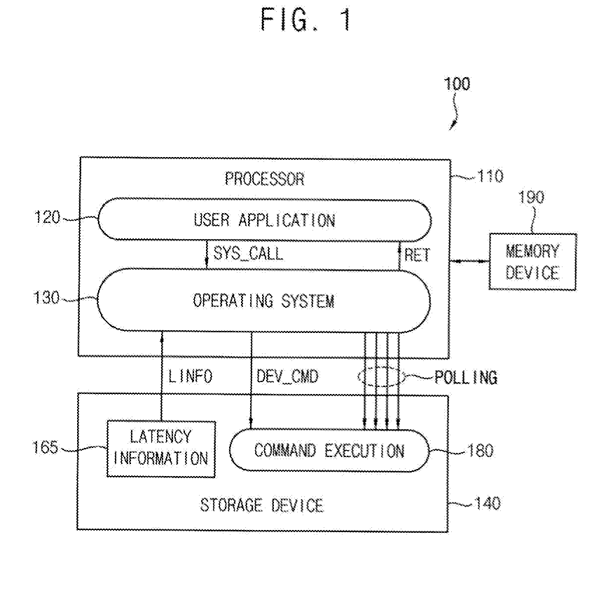

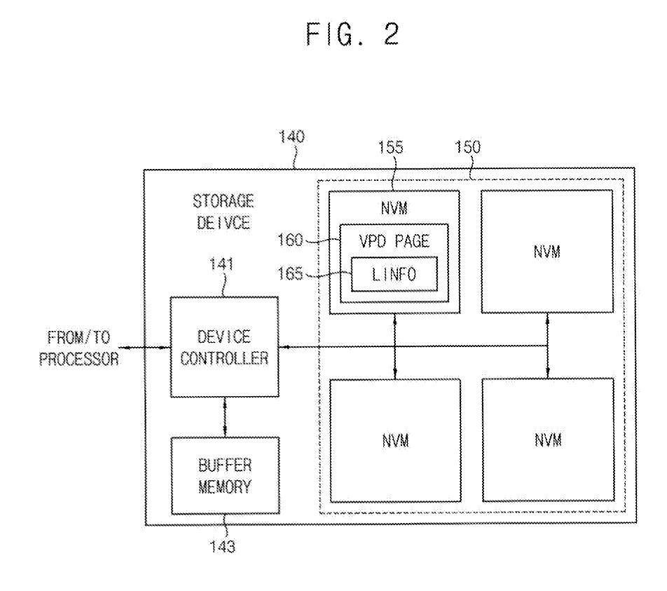

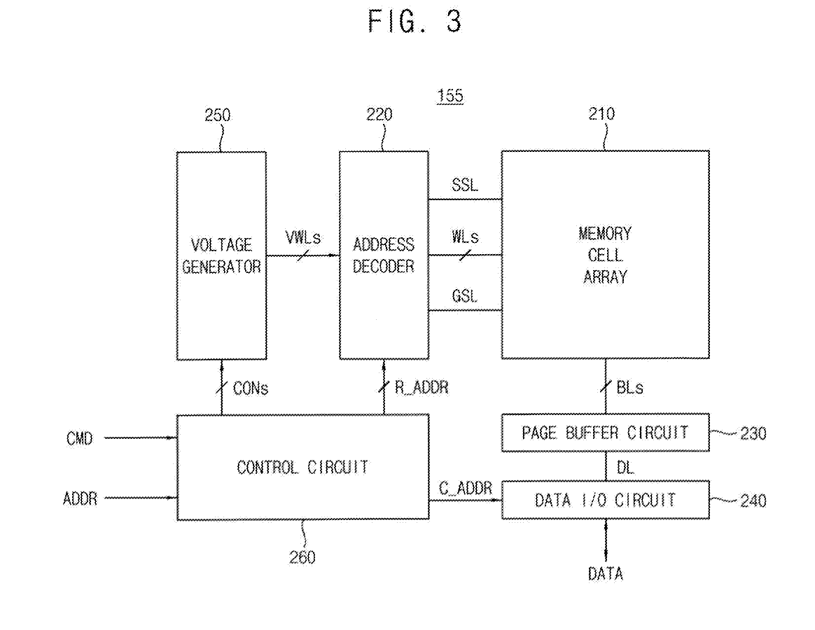

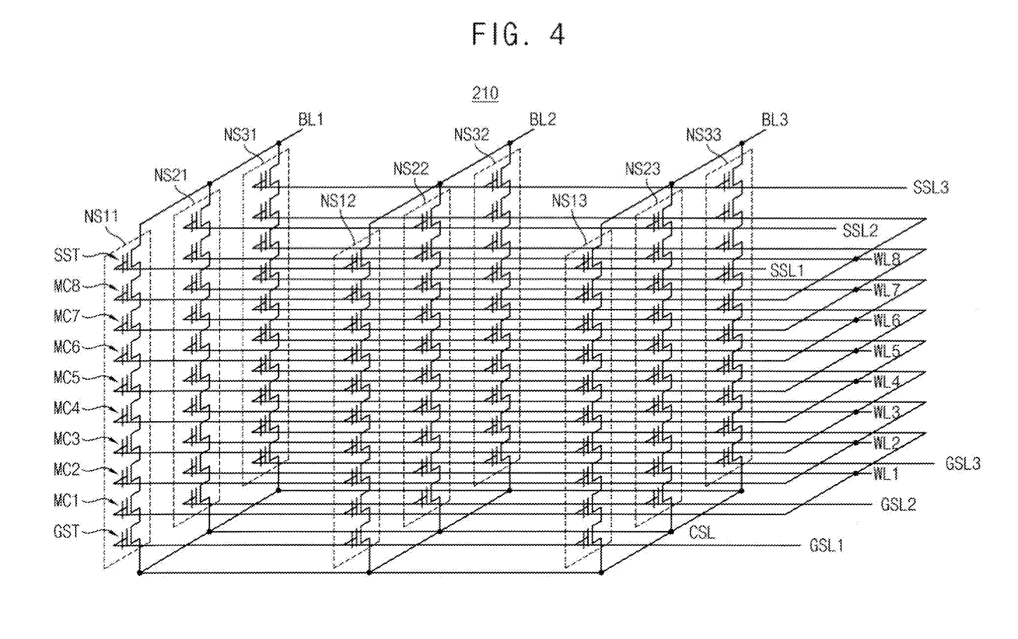

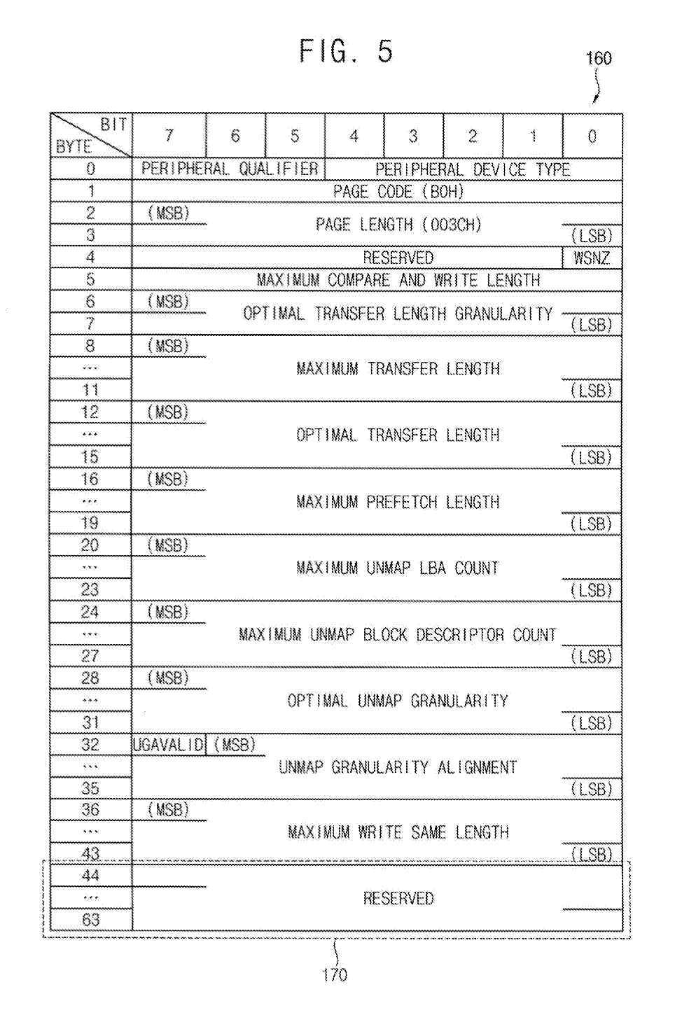

FIG. 1 is a block diagram of a computing system according to exemplary embodiments, FIG. 2 is a block diagram of an example of a storage device according to exemplary embodiments, FIG. 3 illustrates an example of a nonvolatile memory device included in a storage device of FIG. 2, FIG. 4 is a circuit diagram of an example of a memory cell array included in a nonvolatile memory device of FIG. 3, and FIG. 5 illustrates an example of a virtual product data (VPD) page.

Referring to FIG. 1, according to exemplary embodiments, a computing system 100 include a processor 110 that performs particular calculations or tasks, and a storage device 140 that stores data, such as user data, in a file format. The computing system 100 further includes a memory device 190 that operates as a main memory that stores data required for operations of the computing system 100. The computing system 100 may be any electronic device, such as a personal computer, a laptop computer, a server computer, a cellular phone, a smart phone, an MP3 player, a personal digital assistant (PDA), a portable multimedia player (PMP), a digital TV, a digital camera, portable game console, etc.

According to exemplary embodiments, the processor 110 controls the overall operation of the computing system 100. In some exemplary embodiments, the processor 110 is a central processing unit (CPU), a microprocessor, etc. The processor 110 executes an operating system (OS) 130 that operates the computing system 100. The OS 130 includes a kernel that processes input/output requests from a user application 120 and controls peripheral devices. In some exemplary embodiments, the OS 130 further includes a block layer that manages data blocks associated with the input/output requests, device drivers that control the peripheral devices, etc. Further, the processor 110 executes the user application 120 to provide various services. For example, the user application 120 can be a video application, a game application, a web browser application, etc.

According to exemplary embodiments, the memory device 190 stores instructions and data that are executed and processed by the processor 110. For example, the memory device 190 can be implemented with a volatile memory device, such as a static random access memory (SRAM), or a dynamic random access memory (DRAM), but embodiments are not limited thereto.

According to exemplary embodiments, as illustrated in FIG. 1, the storage device 140 is directly connected to the processor 110. In this case, the processor 110 and the storage device 140 communicate with each other using a peripheral component interconnect express (PCIe) interface protocol, but embodiments are not limited thereto. The storage device 140 can be an auxiliary or secondary memory device. For example, the storage device 140 may be a solid state drive (SSD), a nonvolatile memory express (NVMe) SSD, a multi-level cell (MLC)-based SSD, a triple level cell (TLC)-based SSD, a hard disk drive (HDD), etc.

In some exemplary embodiments, the storage device 140 is an SSD that includes a plurality of nonvolatile memory devices, such as a NAND flash memory. For example, as illustrated in FIG. 2, the storage device 140 includes a plurality 150 of nonvolatile memory devices 155 that store data, such as user data, a device controller 141 that controls the plurality 150 of nonvolatile memory devices 155, and a buffer memory 143 that temporarily stores data, such as user data, being transferred between the processor 110 and the plurality 150 of nonvolatile memory devices 155. Although FIG. 2 illustrates an example where the buffer memory 143 is located outside the device controller 141, in other exemplary embodiments, the buffer memory 143 is located inside the device controller 141.

In some exemplary embodiments, as illustrated in FIG. 3, each of the plurality 150 of nonvolatile memory devices 155 includes a memory cell array 210, an address decoder 220, a page buffer circuit 230, a data input/output (I/O) circuit 240, a voltage generator 250 and a control circuit 260.

According to exemplary embodiments, the memory cell array 210 is coupled to the address decoder 220 through a string select line SSL, a plurality of word lines WLs and a ground select line GSL. The memory cell array 210 is further coupled to the page buffer circuit 230 through a plurality of bit lines BLs. The memory cell array 210 includes a plurality of nonvolatile memory cells coupled to the plurality of word lines WLs and the plurality of bit lines BLs.

In some exemplary embodiments, the memory cell array 210 is a three dimensional memory cell array formed as a three dimensional structure or a vertical structure on a substrate. In this case, the memory cell array 210 includes vertical memory cell strings that each have a plurality of stacked memory cells. For example, the memory cell array 210 can be formed in a three dimensional structure as illustrated in FIG. 4. In an example of FIG. 4, a plurality of memory cell strings included in the memory cell array 210 are formed vertically with respect to the substrate.

Referring to FIG. 4, according to exemplary embodiments, the memory cell array 210 includes a plurality of memory cell strings NS11 through NS33 coupled between the bit lines BL1, BL2 and BL3 and a common source line CSL. Each memory cell string NS11 through NS33 includes a string select transistor SST, a plurality of memory cells MCI through MC8 and a ground select transistor GST. Although FIG. 4 illustrates an example where each memory cell string NS11 through NS33 includes eight memory cells MCI through MC8, embodiments of the present inventive concept are not limited thereto.

According to exemplary embodiments, the string select transistor SST is coupled to a corresponding one of string select lines SSL1, SSL2 and SSL3. The memory cells MCI through MC8 are respectively coupled to corresponding word lines WL1 through WL8. The ground select transistor GST is coupled to a corresponding one of ground select lines GSL1, GSL2 and GSL3. The string select transistor SST is further coupled to a corresponding one of the bit lines BL1, BL2 and BL3, and the ground select transistor GST is further coupled to the common source line CSL. Word lines at the same level are coupled to each other, and the string select lines SSL1, SSL2 and SSL3 and the ground select lines GSL1, GSL2 and GSL3 are separated from each other. Although FIG. 4 illustrates an example where the memory cell array 210 are coupled to eight word lines WL1 through WL8 and three bit lines BL1, BL2 and BL3, embodiments of the present inventive concept are not limited thereto.

In other exemplary embodiments, the memory cell array 210 is a two dimensional memory cell array formed in a two dimensional structure or a horizontal structure on a substrate.

Referring again to FIG. 3, according to exemplary embodiments, the control circuit 260 receives a command signal CMD and an address signal ADDR from the device controller 141, and controls a program operation, a read operation and an erasure operation of the nonvolatile memory device 150 based on the command signal CMD and the address signal ADDR. For example, the control circuit 260 generates control signals CONs based on the command signal CMD that control the voltage generator 250, and generates a row address R_ADDR and a column address C_ADDR based on the address signal ADDR. The control circuit 260 provides the row address R_ADDR to the address decoder 220, and the column address C_ADDR to the data I/O circuit 240.

According to exemplary embodiments, the address decoder 220 is coupled to the memory cell array 210 through the string select line SSL, the plurality of word lines WLs and the ground select line GSL. For a write or program operation or a read operation, the address decoder 220 selects one word line from the plurality of word lines WLs based on the row address R_ADDR received from the control circuit 260.

According to exemplary embodiments, the voltage generator 250 generates word line voltages VWLs to operate the nonvolatile memory device 150 based on the control signals CONS received from the control circuit 260. The word line voltages VWLs generated by the voltage generator 250 are applied to the plurality of word lines WLs via the address decoder 220. For a write or program operation, the voltage generator 250 generates a program voltage and a program pass voltage. The program voltage is applied to the selected word lines via the address decoder 220, and the program pass voltage is applied to non-selected word lines via the address decoder 220. For a read operation, the voltage generator 250 generates a read voltage and a read pass voltage. The read voltage is applied to the selected word lines via the address decoder 220, and the read pass voltage is applied to non-selected word lines via the address decoder 220.

According to exemplary embodiments, the page buffer circuit 230 is coupled to the memory cell array 210 through the plurality of bit lines BLs. The page buffer circuit 230 includes a plurality of page buffers. In some exemplary embodiments, each page buffer is coupled to one bit line. In other exemplary embodiments, each page buffer is coupled to two or more bit lines. The page buffer circuit 230 temporarily stores data to be written to a selected page during a write or program operation, and temporarily stores data read from a selected page during a read operation.

According to exemplary embodiments, the data I/O circuit 240 is coupled to the page buffer circuit 230 through a data line DL. During a write or program operation, the data I/O circuit 240 receives program data DATA from the device controller 141, and provides the program data DATA to the page buffer circuit 230 based on the column address C_ADDR received from the control circuit 260. During a read operation, the data I/O circuit 240 provides read data DATA stored in the page buffer circuit 230 to the device controller 141 based on the column address C_ADDR received from the control circuit 260.

Referring again to FIG. 2, according to exemplary embodiments, the device controller 141 controls operations, such as write operations or read operations, of the nonvolatile memory devices 150 based on commands and data received from the processor 110. For example, the device controller 141 can receive, as a storage command, a write command that requests a write operation, and controls the nonvolatile memory device 150 to perform the write operation in response to the write command. In another example, the device controller 141 can receive, as a storage command, a read command that requests a read operation, and controls the nonvolatile memory device 150 to perform the read operation in response to the read command. In some exemplary embodiments, the device controller 141 includes a CPU that controls operation of the device controller 141, an internal memory that stores instructions and data executed and processed by the CPU, a host interface that interfaces with the processor 110, a memory interface that interfaces with the nonvolatile memory devices 150, and a buffer manager that controls write and read operations of the buffer memory 143, but embodiments are not limited thereto. In some exemplary embodiments, the device controller 141 further includes an error correction code (ECC) block to correct errors, a randomizing block to randomize data, etc.

Referring again to FIG. 1, according to exemplary embodiments, the storage device 140 stores latency information LINFO 165 about latency, such as write or read latency, determined from specifications, etc., of each storage device. In some exemplary embodiments, the latency information 165 is written to the storage device 140 by a manufacturer or a vendor when the storage device 140 is manufactured.

In some exemplary embodiments, as illustrated in FIG. 2, the latency information 165 is stored in a memory cell array of at least one nonvolatile memory device NVM 155 of the plurality 150 of nonvolatile memory devices 155. Further, in some exemplary embodiments, as illustrated in FIG. 2, the latency information 165 is stored in a vital product data (VPD) page 160 included in the nonvolatile memory device 155.

According to exemplary embodiments, the VPD page 160 stores vendor specific product information about a logical unit and a target device. For example, as illustrated in FIG. 5, the VPD page 160 includes peripheral qualifier and peripheral device type fields about a peripheral device connected to the logical unit, a page code field that indicates a type of the VPD page, such as an ASCII information VPD page, a data code page, a device behavior, etc., a page length field that indicates a length of VPD page data, a write same non-zero (WSNZ) bit that indicates whether a field of the number of logical blocks of a write same command supports a value of 0, a maximum compare and write length field that indicates a maximum value of a field of the number of logical blocks of a compare and write command, an optimal transfer length granularity field that indicates an optimal transfer length granularity size of logical blocks for a single command, a maximum transfer length field that indicates a maximum transfer length of logical blocks for a single command, an optimal transfer length field that indicates an optimal transfer length of logical blocks for a single command, a maximum prefetch length field that indicates a maximum prefetch length of logical blocks for a single pre-fetch command, a maximum unmap LBA count field that indicates a maximum number of logical block addressing (LBA) that can be unmapped by a unmap command, a maximum unmap block descriptor count field that indicates a maximum number of unmap block descriptors, an optimal unmap granularity field that indicates an optimal granularity for a unmap request, a unmap granularity alignment valid (UGAVALID) bit that indicates whether a unmap granularity alignment field is valid, a unmap granularity alignment field that indicates an LBA of a first logic block to which the optimal unmap granularity field is applied, a maximum write same length field that indicates a maximum value of a field of the number of logic blocks for a write same command, and a reserved field that is not currently used. In some exemplary embodiments, the latency information 165 is stored in the currently unused reserved field, for example the reserved field 170 of BYTE[44] to BYTE[63] of the VPD page 160.

According to exemplary embodiments, the processor 110, or the OS 130 executed by the processor 110, receives the latency information LINFO 165 from the storage device 140. In some exemplary embodiments, the processor 110 or the OS 130 receives the latency information 165 by transmitting a vendor unique command (VUC) to the storage device 140. In other exemplary embodiments, the processor 110 receives the latency information 165 by transmitting a command, such as an inquiry command, previously defined in a standard for the storage device 140 or a command newly added to the standard.

According to exemplary embodiments, the processor 110 determines, based on the latency information 165, a polling delay time that is a time period from a time at which the processor 110 transmits a storage device command DEV_CMD to a time at which the processor 110 initiates polling. In some exemplary embodiments, the storage device command DEV_CMD includes a write command to write user data to the storage device 140, or a read command to read user data from the storage device 140. Further, the latency information 165 includes a write command polling delay time that is a sleep time of the processor 110 after transmitting the write command, and a read command polling delay time that is a sleep time of the processor 110 after transmitting the read command. When receiving a write command from the processor 110, the storage device 140 has a write latency that includes a time for accepting the write command, a time for storing the user data from the processor 110 in the buffer memory 143, a time for writing the user data from the buffer memory 143 to the nonvolatile memory devices 150, and a time for notifying a result of the write operation, and the write command polling delay time corresponds to the write latency of the storage device 140. Further, when receiving a read command from the processor 110, the storage device 140 has a read latency that includes a time for accepting the read command, a time for storing the user data in the buffer memory 143 by reading the user data from the nonvolatile memory devices 150, a time for outputting the user data stored in the buffer memory 143 to the processor 110, and a time for notifying a result of the read operation, and the read command polling delay time corresponds to the read latency of the storage device 140.

According to exemplary embodiments, the processor 110 determines the write command polling delay time included in the latency information 165 as the polling delay time for the write command, and determines the read command polling delay time included in the latency information 165 as the polling delay time for the read command. Thus, the processor 110 waits in a sleep or standby state for the duration of a polling delay time, such as the write command polling delay time or the read command polling delay time, determined based on the latency information 165, after transmitting the storage device command, such as a write command or a read command, DEV_CMD. After the polling delay time, determined from the time the storage device command DEV_CMD was transmitted, has expired, the processor 110 initiates polling that checks the state of the storage device 140.

For example, according to exemplary embodiments, when a user application calls SYS_CALL a system function, such as a write function or a read function, the OS 130 transmits the storage device command DEV_CMD, such as the write command or the read command, to the storage device 140. The storage device 140 executes 180 the process requested by the storage device command DEV_CMD. At this time, the processor 110 enters a sleep state for the duration of the polling delay time determined based on the latency information 165. After the polling delay time has expired, the OS 130 of the processor 110 initiates polling to check the state of the storage device 140. Once the command process of the storage device 140 is completed, the OS 130 becomes aware of the completion of the command process by the polling operation.

According to exemplary embodiments, in an interrupt request (IRQ) method where the processor 110 receives an interrupt from the storage device 140 that indicates the completion of the command process, delays due to, for example, an interrupt transfer delay by an interrupt handler that handles the interrupt from the storage device 140, or a context switch over delay, can occur, and thus the operation that corresponds to the storage device command may not be executed quickly. On the other hand, when the processor 110 periodically performs polling immediately after transmitting the storage device command, processor load or processor usage is increased. According to exemplary embodiments, to reduce processor load or usage, a hybrid polling method can be considered. In a hybrid polling method according to an embodiment, the processor 110 predicts a write/read latency of the storage device 140 based on a command queue for the storage devices 140, and initiates polling after a polling delay time that corresponds to the predicted write/read latency. Alternatively, in a hybrid polling method according to another embodiment, the processor 110 receives the polling delay time from a user or the user application 120, and initiates polling after expiration of the polling delay time received from the user. However, this prediction by the processor 110 or input from a user may not properly reflect characteristics of each storage device 140 as based on their specifications.

However, according to exemplary embodiments, in the computing system 100 that includes the storage device 140, the latency information 165 is stored in the storage device 140. Further, after transmitting the storage device command DEV_CMD, the processor 110 enters a sleep state for the duration of the polling delay time determined from the latency information 165 received from the storage device 140, and initiates polling after expiration of the polling delay time. That is, the polling delay time, which is a time period from the time at which the storage device command DEV_CMD is transmitted to a time point at which polling is initiated, is determined based on the latency information 165 that corresponds to the write/read latency of each storage device 140 based on their respective specifications, and thus the processor 110 can enter a sleep state for the duration of the polling delay time for each storage device 140. Further, since the processor 110 is in a sleep state for the duration of the polling delay time, processor load or caused by the periodic polling can be reduced.

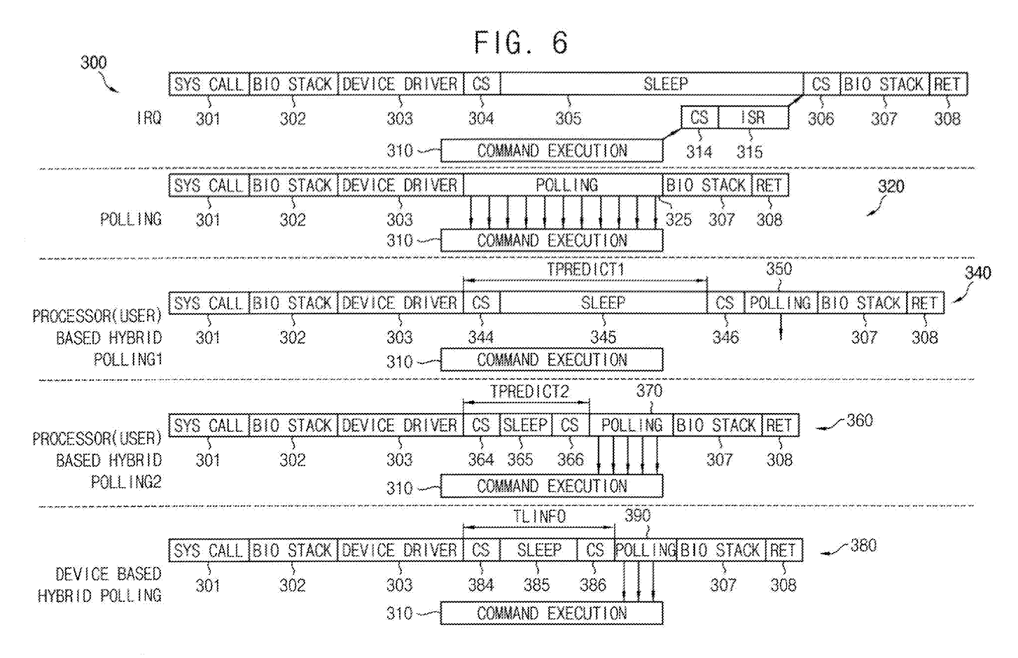

FIG. 6 is a timing diagram of an input/output operation in an interrupt request (IRQ) method, an input/output operation in a polling method, a first input/output operation in a processor- or user-based hybrid polling method, a second input/output operation in the processor- or user-based hybrid polling method, and an input/output operation in a device-based hybrid polling method according to exemplary embodiments.

In FIG. 6, reference number 300 represents an input/output operation in an IRQ method, reference number 320 represents an input/output operation in a polling method, reference number 340 represents a first input/output operation in a processor- or user-based hybrid polling method, reference number 360 represents a second input/output operation in the processor- or user-based hybrid polling method, and reference number 380 represents an input/output operation in a device-based hybrid polling method according to exemplary embodiments.

Referring to FIGS. 1 and 6, according to exemplary embodiments, referring to reference numeral 300, when a user application 120 requests an input or write operation for a storage device 140, or an output or read operation for the storage device 140, the user application 120 performs a system function call 301, OS 130 performs a basic input/output (BIO) stack process 302, and then a device driver for the storage device 140 performs a device driver process 303 that transmits the storage device command to the storage device 140. The storage device 140 executes 310 the process requested by the storage device command. The system function call 301, BIO stack process 302, device driver process 303 and command process execution 310 are performed not only in an IRQ method but also in a polling method, a processor- or user-based hybrid polling method and a device-based hybrid polling method, and these processes 301, 302, 303 and 310 require substantially the same time in those methods. In the IRQ method, the processor 110 enters a sleep or standby state 305 until the processor 110 receives an interrupt from the storage device 140. When the processor 110 enters or exits sleep state 305, context switching (CS) 304 and 306 are performed. For example, once the storage device 140 completed executing the command process 310, the storage device 140 will generate the interrupt. An interrupt handler executes an interrupt service routine (ISR) 315 that transfers the interrupt from the storage device 140 to the OS 130. When the ISR 315 is executed, a CS 314 is performed. When the OS 130 receives the interrupt from the interrupt handler, the processor 110 exits from the sleep state 302, and performs, after the CS 306, a BIO stack process 307 and returns 308 a result for the system function call 301. The BIO stack process 307 and system function call result return 308 are performed not only in the IRQ method but also in the polling method, the processor- or user-based hybrid polling method and the device-based hybrid polling method, and these processes 307 and 308 require substantially the same time in those methods. In this IRQ method, since additional time for the CS 314 and 306 and the ISR 315 is required, the input/output operation is not executed as quickly.

Referring to reference numeral 320, according to an embodiment, in a polling method, the processor 110, such as a device driver included in the OS 130 of the processor 110, after transmitting the storage device command to the storage device 140, performs a polling operation 325 that checks the state of the storage device 140, or whether the command process 310 has been executed by the storage device 140. Compared with the IRQ method, this polling method will more quickly execute the input/output operation by eliminating the time for the CS 314 and 306 and the ISR 315, but with an increased processor load or usage.

According to exemplary embodiments, to obviate the increased processor load or usage of polling, a processor-based hybrid polling method can predict write/read latency of the storage device based on, for example, the number of commands included in a command queue, and performs polling after standing-by for the duration of a polling delay time that corresponds to the predicted latency. Alternatively, to obviate the increased processor load or usage of polling, a user-based hybrid polling method can receive the polling delay time from a user or the user application 120, and performs polling after standing-by for the duration of the polling delay time received from the user. However, this processor- or user-based hybrid polling method may not properly reflect characteristics of each storage device 140 based on their respective specifications, and thus the polling delay time determined by the processor 110 or the user may not match an actual write/read latency of the storage device 140.

For example, according to an embodiment, referring to reference numeral 340, in a processor- or user-based hybrid polling method, after transmitting the storage device command, the processor 110 enters a sleep or standby state 345 for the duration of a first predicted time TPREDICT1. When the processor 110 enters or exits sleep state 345, CS 344 and 346 are performed. However, the first predicted time TPREDICT1 may be longer than the actual write/read latency of the storage device 140, or a time for executing the command process 310. If the first predicted time TPREDICT1 is longer than the execution time of the command process 310, the processor or device driver 110 performs polling 50 for an undesired time duration after the command process 310 has finished executing, which can increase the time for the input/output operation.

In another example, according to an embodiment, referring to reference numeral 360, in a processor- or user-based hybrid polling method, after transmitting the storage device command, the processor 110 enters a sleep or standby state 365 for the duration of a second predicted time TPREDICT1. When the processor 110 enters or exits sleep state 365, CS 364 and 366 are performed. However, the second predicted time TPREDICT1 may be shorter than the actual write/read latency of the storage device 140, or the time for executing the command process 310. If the second predicted time TPREDICT1 is shorter than the execution time of the command process 310, the processor or device driver 110 performs polling operation 370 longer than necessary, which increases the processor load or usage.

However, in a device-based hybrid polling method according to exemplary embodiments, the processor 110 determines a polling delay time TLINFO based on latency information 165 stored in the storage device 140, which is determined based on a specification, etc., of each storage device 140. Accordingly, the polling delay time TLINFO corresponds to the actual write/read latency of the storage device 140. That is, the polling delay time TLINFO is neither longer nor shorter than the time for executing the command process 310.

For example, referring to reference numeral 380, in a device-based hybrid polling method according to exemplary embodiments, after transmitting the storage device command, the processor 110 enters a sleep or standby state 385 for the duration of the polling delay time TLINFO determined from the latency information 165 stored in the storage device 140. When the processor 110 enters or exits sleep state 385, CS 384 and 386 are performed. The polling delay time TLINFO determined from the latency information 165 stored in the storage device 140 corresponds to the execution time for the command process 310. Thus, the processor 110 initiates polling 390 at a proper time point when the command process 310 has finished executing, which can decrease the processor load or usage while decreasing the time for the input/output operation.

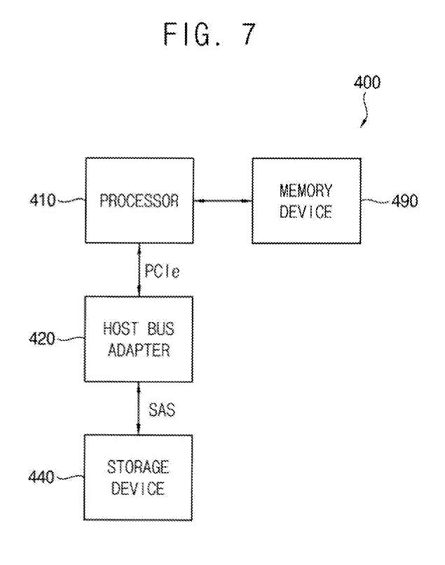

FIG. 7 is a block diagram of a computing system according to exemplary embodiments. Referring to FIG. 7, a computing system 400 according to exemplary embodiments includes a processor 410, a storage device 440, and a host bus adapter (HBA) 420 connected to the processor 410 and the storage device 440. In some exemplary embodiments, the computing system 400 further includes a memory device 490 that operates as a main memory. The computing system 400 of FIG. 7 has similar operations and configurations to those of a computing system 100 of FIG. 1, except that the computing system 400 further includes the HBA 420.

According to exemplary embodiments, the HBA 420 provides physical connectivity between the processor 410 and the storage device 440. In some exemplary embodiments, the processor 410 and the HBA 420 communicate with each other using a PCIe interface protocol, but embodiments are not limited thereto, and the HBA 420 and the storage device 440 can communicate with each other using a serial-attached small computer system interface (SAS) protocol, but embodiments are not limited thereto.

Embodiments of present inventive concept can be incorporated into any storage device and any computing system that includes the storage device. For example, embodiments of the present inventive concept can be incorporated into a storage device, such as an SSD, an NVMe SSD, an MLC-based SSD, a TLC-based SSD, an HDD, etc., and a computing system that includes the storage device.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and features of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A computing system comprising:
a storage device that includes a plurality of nonvolatile memory devices, wherein the storage device stores user data and latency information in the plurality of nonvolatile memory devices; and
a processor that receives the latency information from the storage device, determines a polling delay time based on the latency information, transmits a storage device command to the storage device, and initiates polling that checks a state of the storage device after expiration of the polling delay time, as determined from a time when the storage device command was transmitted.

2. The computing system of claim 1, wherein the storage device command includes a write command that writes the user data to the storage device, or a read command that reads the user data from the storage device, and
wherein the latency information includes a write command polling delay time that is a sleep time of the processor after transmitting the write command, and a read command polling delay time that is a sleep time of the processor after transmitting the read command.

3. The computing system of claim 1, wherein the latency information is stored in at least one of the plurality of nonvolatile memory devices.

4. The computing system of claim 1, wherein the latency information is stored in a vital product data (VPD) page included in one of the plurality of nonvolatile memory devices.

5. The computing system of claim 4, wherein the latency information is stored in a reserved field of the VPD page.

6. The computing system of claim 1, wherein the latency information is written to the storage device when the storage device is manufactured.

7. The computing system of claim 1, wherein the processor enters a sleep state for a duration of the polling delay time after transmitting the storage device command.

8. The computing system of claim 1, wherein the storage device is directly connected to the processor.

9. The computing system of claim 8, wherein the processor and the storage device communicate with each other using a peripheral component interconnect express (PCIe) interface protocol.

10. The computing system of claim 1, further comprising:
a host bus adapter (HBA) connected to the processor and the storage device.

11. The computing system of claim 10, wherein the processor and the HBA communicate with each other using a PCIe interface protocol, and
wherein the HBA and the storage device communicate with each other using a serial-attached small computer system interface (SAS) protocol.

12. A processor that executes instructions to perform method steps for operating a storage device, the method steps comprising:
receiving latency information from the storage device;
determining a polling delay time based on the latency information;
transmitting a storage device command to the storage device; and
initiating a polling operation that checks a state of the storage device after expiration of the polling delay time, as determined from a time when the storage device command was transmitted,
wherein the processor is connected to the storage device.

13. The processor of claim 12, wherein the storage device command includes a write command that writes user data to the storage device, and a read command that reads the user data from the storage device, and
wherein the latency information includes a write command polling delay time that is a sleep time of the processor after transmitting the write command, and a read command polling delay time that is a sleep time of the processor after transmitting the read command.

14. The processor of claim 12, wherein the processor enters a sleep state for duration of the polling delay time after transmitting the storage device command.

15. The processor of claim 12, wherein the processor directly communicates with the storage device using a PCIe interface protocol.

16. The processor of claim 12, wherein the processor communicates with the storage device using an HBA.

17. A storage device comprising:
a plurality of nonvolatile memory devices,
wherein the storage device stores user data in the plurality of nonvolatile memory devices; and stores latency information used to determine a polling delay time of a storage device command.

18. The storage device of claim 17, wherein the storage device stores the latency information in at least one of the plurality of nonvolatile memory devices.

19. The storage device of claim 17, wherein the storage device stores the latency information in a VPD page included in one of the plurality of nonvolatile memory devices.

20. The storage device of claim 19, wherein the latency information is stored in a reserved field of the VPD page.
